(19) United States
(12) Patent Application Publication
(10) Pub. No.: US 2007/0264570 A1
(43) Pub. Date: Nov. 15, 2007

(54) BINDER OF POLYVINYL ALCOHOL CROSSLINKED WITH POLYURETHANE AND LITHIUM SECONDARY BATTERY EMPLOYED WITH THE SAME

(75) Inventors: Eun-Suok OH, Daejeon (KR); Young-Min KIM, Daejeon (KR); SeungRim YANG, Daejeon (KR); Juhyun KIM, Seoul (KR); Ki Woo CHUN, Daejeon (KR); Minjung RYU, Seoul (KR); ChanHong LEE, Daejeon (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/560,510

(22) Filed: Nov. 16, 2006

(30) Foreign Application Priority Data
Jan. 18, 2006 (KR) 10-2006-0005186

(51) Int. Cl. H01M 4/62

(52) U.S. Cl. 429/217

(57) ABSTRACT

Provided is a binder having a crosslinked structure of a polyvinyl alcohol having superior adhesive strength between an active material and a current collector and between the active materials, crosslinked with polyurethane, in order to improve elasticity and solvent resistance to an electrolyte. Therefore, the binder of the present invention improves the battery performance by inhibiting deterioration of adhesive strength due to dissolution and swelling thereof in an electrolyte and by preventing peeling and separation of an electrode active material layer from a current collector, resulting from volume changes during charge/discharge cycles.

### FIELD OF THE INVENTION

The present invention relates to a polyvinyl alcohol binder crosslinked with polyurethane and a lithium secondary battery comprising the same. More specifically, the present invention relates to a polyurethane-crosslinked polyvinyl alcohol binder which enables preparation of a high-capacity battery by increasing a solvent resistance of a polyvinyl alcohol to a carbonate-based electrolyte and inhibiting volume changes of an electrode occurring during charge/discharge cycles thereby preventing occurrence of cracks in the electrode, through the use of a crosslinked polymer of a polyvinyl alcohol having superior adhesive strength between an active material and a current collector and between the active materials crosslinked with polyurethane having high elasticity, as a binder of an anode; and a lithium secondary battery comprising the same

### BACKGROUND OF THE INVENTION

Technological development and increased demand for mobile equipment have led to a rapid increase in the demand for secondary batteries as an energy source. Among these secondary batteries, lithium secondary batteries having high energy density and voltage are commercially available and widely used. The lithium secondary batteries generally use a lithium transition metal oxide as a cathode active material and a graphite-based material as an anode active material.

However, the anode formed of the graphite-based material has a maximum theoretical capacity of only 372 mAh/g (844 mAh/cc), thus suffering from a limited increase of capacity thereof. Consequently, such a graphite-based anode is incapable of carrying out a sufficient role as an energy source for next-generation mobile equipment undergoing rapid development and advancement. Further, lithium metals, studied for use as the anode material, have a very high energy density and thus may realize a high capacity, but raise problems associated with safety concerns due to growth of dendrites and a shortened cycle life as charge/discharge cycles are repeated. In addition, use of carbon nanotubes (CNTs) has been attempted as an anode active material, but various problems have been pointed out such as low productivity, expensiveness and low initial efficiency of less than 50%.

In this connection, a number of studies and suggestions have been recently proposed as to silicon, tin or alloys thereof, as they are known to be capable of performing reversible absorption (intercalation) and desorption (deintercalation) of large amounts of lithium ions through the reaction with lithium. For example, silicon (Si) has a maximum theoretical capacity of about 4020 mAh/g (9800 mAh/cc, a specific gravity of 2.23) which is substantially greater than the graphite-based materials, and thereby is promising as a high-capacity anode material.

However, upon performing charge/discharge processes, silicon, tin or alloys thereof react with lithium, thus undergoing significant changes of volume, i.e., ranging from 200 to 300%, and therefore repeated charge/discharge may result in separation of the anode active material from the current collector, or significant physicochemical changes at contact interfaces between the anode active materials, which are accompanied by increased resistance. Therefore, as charge/discharge cycles are repeated, the battery capacity sharply drops, thus suffering from a shortened cycle life thereof. For these problems, when a conventional binder for a graphite-based anode active material, i.e., polyvinylidene fluoride or styrene butadiene rubber, without any special treatment or processing, is directly applied to a silicon- or tin-based anode active material, it is impossible to achieve desired effects. In addition, when an excessive amount of a polymer as a binder is used to decrease volume changes occurring during charge/discharge cycles, separation of the active material from the current collector may be decreased slightly, but the electrical resistance of the anode is increased by an electrical insulating polymer used as the binder and the amount of the active material is relatively decreased, which consequently results in problems associated with a reduced battery capacity.

In order to cope with such problems, there is an urgent need for the development of a binder exhibiting superior adhesive strength and mechanical properties sufficient to withstand large volume changes of anode active materials occurring during a charge/discharge process in lithium secondary batteries using silicon- or tin-based anode active materials. In addition, conventional graphite-based lithium secondary batteries also require a strong need for the technique which is capable of improving the battery capacity by securing sufficient adhesion between the active material and current collector and/or between the active materials, even with use of a small amount of the binder.

On the other hand, use of a polyvinyl alcohol or thermosetting plasticized polyvinyl alcohol exhibiting excellent adhesive strength has been attempted as a binder for an electrode of a lithium secondary battery (Japanese Patent Laid-open Publication Nos. 1999-67216, 2003-109596 and 2004-134208), and use of polyurethane has also been attempted as a binder for an electrode of a lithium secondary battery (Japanese Patent Laid-open Publication Nos. 1998-219098 and 1999-1676).

However, the above-mentioned polyvinyl alcohol binder exhibits superior adhesive strength, as compared to conventional binders, but suffers from a very low viscosity, non-uniform application of the binder on copper foil as a current collector and process problems associated with thermal treatment needed to improve adhesion between an electrode mix and current collector. Further, the polyvinyl alcohol is soluble in the carbonate-based electrolyte and therefore undergoes weakening of the adhesive strength over time. The thus-dissolved polyvinyl alcohol is probably susceptible to adverse side reactions with electrolytes and the like, thereby limiting application thereof as the binder of the lithium secondary battery.

Further, when it is used as the binder for the electrode of the lithium secondary battery, polyurethane undergoes severe swelling in the electrolyte and is known to exhibit relatively insignificant adhesive strength as compared to the polyvinyl alcohol.

### SUMMARY OF THE INVENTION

Therefore, the present invention has been made to solve the above problems and other technical problems that have yet to be resolved.

As a result of a variety of extensive and intensive studies and experiments to solve the problems as described above, the inventors of the present invention have discovered that a copolymer of a polyvinyl alcohol, which has superior adhesive strength to copper foil and current collector but is soluble in an electrolyte such as ethyl carbonate, ethyl methyl carbonate or diethyl carbonate, crosslinked with polyurethane having superior elasticity can be used as a binder having superior adhesive strength and elasticity, due to prevention of dissolution of the polyvinyl alcohol in the electrolyte and capability to control the degree of swelling. The present invention has been completed based on these findings.

As such, it is one object of the present invention to provide a high-capacity lithium secondary battery which can be used as an energy source of next-generation mobile equipment, by preparation of an anode for a lithium secondary battery using the above-mentioned copolymer binder in admixture with a silicon-, tin- or graphite-based anode active material.

### DETAILED DESCRIPTION OF PREFERRED EMBODIMENTS

In accordance with an aspect of the present invention, the above and other objects can be accomplished by the provision of a binder for an electrode mix of a secondary battery, comprising a crosslinked copolymer of a polyvinyl alcohol crosslinked with polyurethane.

The binder according to the present invention is insoluble in an electrolyte due to chemical crosslinking of a polyvinyl alcohol with polyurethane, is capable of preventing deterioration of the adhesive strength by controlling the degree of swelling in the electrolyte via modification of the morphology and composition of polyurethane, and exhibits remarkably improved elasticity of the binder due to inherent high elastic properties of polyurethane. Therefore, application of the binder according to the present invention to a secondary battery enables maintenance of stable adhesion between electrode active materials undergoing significant volume changes during charge/discharge cycles and/or stable adhesion between the electrode active material and current collector, and prevention of electrode cracking via inhibition of volume changes occurring during charge/discharge cycles. Consequently, the binder of the present invention provides improved charge/discharge cycle characteristics of the battery, and particularly can provide a large-capacity lithium secondary battery, based on silicon- or tin-based active materials undergoing significant volume changes during charge/discharge cycles.

There is no particular limit to the polyvinyl alcohol that can be used in the present invention, regardless of a degree of polymerization (DP) and a degree of saponification (DS). However, an excessively low degree of polymerization may result in deterioration of mechanical strength, adhesive strength and solvent resistance, whereas an excessively high degree of polymerization may undesirably result in decreased elasticity and poor handleability associated with poor dissolution in the solvent during a manufacturing process of the electrode mix. On the other hand, an excessively low degree of saponification (DS) leads to decreased numbers of hydroxyl (OH) functional groups which are responsible for adhesion between the active material and current collector such as metal foil, thereby lowering the adhesive strength. Hence, more preferred is a polyvinyl alcohol having a high degree of saponification, if it exhibits good handleability in the solvent. Taken altogether, the polyvinyl alcohol utilized in the present invention preferably has a degree of polymerization of more than 2000 and a degree of saponification of more than 80%, more preferably a degree of polymerization of more than 2500 and a degree of saponification of more than 90%.

The polyurethane prevents dissolution of the polyvinyl alcohol in the carbonate-based electrolyte via formation of a crosslinking structure with the polyvinyl alcohol and serves to exert buffering action upon occurrence of volume changes. The polyurethane that can be used in the present invention may be one prepared using various kinds of monomers and methods.

For example, polyurethane may be prepared by bulk or suspension polymerization of polyol and isocyanate. Among the molecular structure of polyurethane, the polyol constituting the soft segment of polyurethane and determining the elasticity and softness thereof may be polyethylene glycol (PEG), polypropylene glycol (PPG), polyisobutylene, polytetramethylene glycol (PTMG), polycaprolactone, polyethylene adipate or glycerine. Whereas, as the isocyanate which is the hard segment of polyurethane, there may be used, for example, 4,4-diphenylmethane diisocyanate (MDI), 2,4-, 2,6-toluene diisocyanate (TDI), 4,4-dicyclohexylmethane diisocyanate (H₁₂MDI), trans-1,4-cyclohexane diisocyanate (CHDI), isophorone diisocyanate (IPDI:), tetramethyl-1,3-xylene diisocyanate (TMXDI), dimeryl diisocyanate (DDI) and hexamethylene diisocyanate (HMDI). Besides them, in order to adjust the structure and physical properties of polyurethane, catalysts such as 1,4-diazabicyclo octane and dibutyltin dilaurate, and a ring extender such as 1,4-butanediol may be additionally employed.

The polyurethane, prepared using various materials and methods including the above-mentioned contents, forms a binder for a lithium secondary battery having superior electrolyte resistance and elasticity by the formation of a crosslinking structure with the polyvinyl alcohol.

Even though there is no particular limit to the molecular weight of polyurethane crosslinked with the polyvinyl alcohol, an excessively low molecular weight of polyurethane results in a difficulty to exert superior elasticity of polyurethane in the binder, whereas an excessively high molecular weight of polyurethane results in a difficulty to exert superior adhesive properties of the polyvinyl alcohol in the binder. Therefore, the molecular weight of polyurethane is preferably in the range of 1000 to 150,000.

The binder of the present invention may contain polyurethane in an amount of 0.1 to 100 parts by weight, preferably 1 to 50 parts by weight, based on 100 parts by weight of the polyvinyl alcohol. If the content of polyurethane is excessively low, the electrolyte resistance and elasticity of the binder are insufficient, thereby resulting in deterioration of adhesive strength and charge/discharge efficiency. On the other hand, if the content of polyurethane is excessively high, a high affinity of polyurethane for the electrolyte results in absorption of excessive amounts of the electrolyte and swelling of polyurethane, which may, in turn, undesirably cause separation of the electrode from the current collector.

In accordance with another aspect of the present invention, there is provided an electrode for a secondary battery comprising the above-mentioned binder.

The secondary battery electrode is fabricated by coating a current collector with an electrode mix containing an electrode active material, a binder, and optionally a conductive material and/or a filler. Specifically, the electrode may be fabricated by adding the electrode mix to a solvent to thereby prepare a slurry, and applying the resulting slurry to the current collector such as metal foil, followed by drying and rolling, thereby obtaining a sheet-like electrode.

The binder of the present invention may be serviceable for an anode and/or cathode, more preferably may be used as the anode binder. In particular, such a binder can be preferably employed when it is desired to use the silicon-, tin- or silicon/carbon-based active material, having a high capacity while exhibiting significant volume changes during repeated charge/discharge cycles, as the anode active material.

The term “silicon- or tin-based anode active material” is intended to encompass silicon (Si) particles, tin (Sn) particles, silicon-tin alloy particles, silicon alloy particles, tin alloy particles, composites thereof and the like. Representative examples of the above-mentioned alloys include, but are not limited to, solid solutions, intermetallic compounds and eutectic alloys of Al—Si, Mn—Si, Fe—Si and Ti—Si. As one preferred example of the composite, a silicon/graphite composite may be used and is found in International Publication No. WO 2005/011030, assigned to the present applicant, the disclosures of which are incorporated by reference herein in their entirety. The graphite may be natural or artificial graphite. In addition, the form of graphite is not particularly limited and may be amorphous, plate-like, flaky or grain-like.

The binder may be contained in an amount of about 1 to 50% by weight, preferably 2 to 20% by weight, based on the total weight of the electrode mix. If the content of the binder is too low, it is difficult to exert the capability of the binder to withstand volume changes occurring during charge/discharge cycles. On the other hand, if the content of the binder is too high, this undesirably leads to decreased capacity and increased resistance of the electrode.

Even though the binder may be added in the form of a crosslinked material, the binder may be preferably allowed to undergo the crosslinking reaction during the fabrication process of the electrode involving applying to a current collector an electrode slurry, prepared by adding to a solvent an electrode mix containing an electrode active material, a polyvinyl alcohol and polyurethane having isocyanate groups at both ends thereof, followed by drying and rolling.

The isocyanate groups present at both ends of polyurethane, due to high reactivity, may undergo crosslinking reaction even at room temperature, and the crosslinking reaction takes place at least upon drying of the slurry. Drying of the slurry may be carried out at a temperature of 50 to 200° C., preferably 60 to 130° C.

Preferred examples of solvents used in preparation of the electrode slurry may include dimethyl sulfoxide (DMSO) and N-methyl pyrrolidone (NMP). The solvent may be used in an amount of up to 400% by weight, based on the total weight of the electrode mix, and is removed during the drying process.

In addition to the electrode active material, and the binder according to the present invention, as mentioned hereinbefore, the electrode mix may further include other components such as a cross-linking accelerator, a viscosity adjuster, a conductive material, a filler, a coupling agent and an adhesive accelerator, which are used alone or in any combination thereof.

The cross-linking accelerator is a component added to improve the cross-linking degree between the polyvinyl alcohol and polyurethane, and may be added in an amount of 0.1 to 50 parts by weight, based on 100 parts by weight of polyurethane. Examples of the cross-linking accelerator may include, but are not limited to, higher polyamines such as polyisocyanate, diethylene triamine (DETA), triethylene diamine (TEDA) and triethylene tetramine (TETA), which have several functional groups per molecule.

The viscosity adjuster is a component used to adjust the viscosity of the electrode mix, such that a mixing process of the electrode mix and an application process of the electrode mix to the current collector can be facilitated. The viscosity adjuster may be added in an amount of up to 30% by weight, based on the total weight of the electrode mix. Examples of the viscosity adjuster may include, but are not limited to, carboxymethyl cellulose and polyvinylidene fluoride. Where appropriate, the above-mentioned solvent may also serve as the viscosity adjuster.

The conductive material is a component used to further improve the conductivity of the electrode active material and may be added in an amount of 1 to 20% by weight, based on the total weight of the electrode mix. There is no particular limit to the conductive material, so long as it has suitable conductivity without causing chemical changes in the fabricated battery. As examples of conductive materials, mention may be made of conductive materials, including graphite such as natural or artificial graphite; carbon blacks such as carbon black, acetylene black, Ketjen black, channel black, furnace black, lamp black and thermal black; conductive fibers such as carbon fibers and metallic fibers; metallic powders such as carbon fluoride powder, aluminum powder and nickel powder; conductive whiskers such as zinc oxide and potassium titanate; conductive metal oxides such as titanium oxide; and polyphenylene derivatives.

The filler is an auxiliary component used to inhibit electrode expansion. There is no particular limit to the filler, so long as it does not cause chemical changes in the fabricated battery and is a fibrous material. As examples of the filler, there may be used olefin polymers such as polyethylene and polypropylene; and fibrous materials such as glass fiber and carbon fiber.

The coupling agent is an auxiliary component used to increase adhesive strength between the active material and binder, and is characterized by having two or more functional groups. The coupling agent may be added in an amount of up to 30% by weight, based on the weight of the binder. The coupling agent may be a material in which one functional group forms a chemical bond via reaction with a hydroxyl or carboxyl group present on the surface of the silicon-, tin- or graphite-based active material, and the other functional group forms a chemical bond via reaction with the polymer binder. Specific examples of the coupling agent that can be used in the present invention may include, but are not limited to, silane-based coupling agents such as triethoxysilylpropyl tetrasulfide, mercaptopropyl triethoxysilane, aminopropyl triethoxysilane, chloropropyl triethoxysilane, vinyl triethoxysilane, methacryloxypropyl triethoxysilane, glycidoxypropyl triethoxysilane, isocyanatopropyl triethoxysilane and cyanatopropyl triethoxysilane.

The adhesive accelerator is an auxiliary component used to improve adhesive strength of the anode active material to the current collector, and may be added in an amount of less than 10% by weight, based on the weight of the binder. Examples of the adhesive accelerator that can be used in the present invention may include oxalic acid, adipic acid, formic acid, acrylic acid derivatives, itaconic acid derivatives and the like.

In the electrode according to the present invention, the current collector is the site where migration of electrons takes place in the electrochemical reaction of the electrode active material, and includes an anode current collector and a cathode current collector.

The anode current collector is generally fabricated to have a thickness of 3 to 500 μm. There is no particular limit to the anode current collector, so long as it has suitable conductivity without causing chemical changes in the fabricated battery. As examples of the anode current collector, mention may be made of copper, stainless steel, aluminum, nickel, titanium, sintered carbon, copper or stainless steel having a surface treated with carbon, nickel, titanium or silver, and aluminum-cadmium alloys.

The cathode current collector is generally fabricated to have a thickness of 3 to 500 μm. There is no particular limit to the cathode current collector, so long as it has high conductivity without causing chemical changes in the fabricated battery. As examples of the cathode current collector, mention may be made of stainless steel, aluminum, nickel, titanium, sintered carbon and aluminum or stainless steel which was surface-treated with carbon, nickel, titanium or silver.

These current collectors may also be processed to form fine irregularities on the surfaces thereof so as to enhance adhesive strength to the electrode active materials. In addition, the current collectors may be used in various forms including films, sheets, foils, nets, porous structures, foams and non-woven fabrics.

As the electrode active materials that can be used in the present invention, examples of the anode active material may include carbon-, silicon-, tin-, and silicon/carbon-based materials, and examples of the cathode active material may include layered compounds such as lithium cobalt oxide (LiCoO₂) and lithium nickel oxide (LiNiO₂), or compounds substituted with one or more transition metals; lithium manganese oxides such as compounds of Formula Li₁₊ₓMn₂₋ₓO₄ (0≦x≦0.33), LiMnO₃, LiMn₂O₃ and LiMnO₂; lithium copper oxide (Li₂CuO₂); vanadium oxides such as LiV₃O₈, V₂O₅ and Cu₂V₂O₇; Ni-site type lithiated nickel oxides of Formula LiNi₁₋ₓMₓO₂ (M=Co, Mn, Al, Cu, Fe, Mg, B or Ga, and 0.01≦x≦0.3); lithium manganese composite oxides of Formula LiMn₂₋ₓMₓO₂ (M=Co, Ni, Fe, Cr, Zn or Ta, and 0.01≦x≦0.1), or Formula Li₂Mn₃MO₈ (M=Fe, Co, Ni, Cu or Zn); LiMn₂O₄ wherein a portion of Li is substituted with alkaline earth metal ions; disulfide compounds; LiFe₃O₄, Fe₂(MoO₄)₃, and the like.

In accordance with yet another aspect of the present invention, there is provided a lithium secondary battery comprising the above-mentioned electrode.

The lithium secondary battery is made of a structure in which an electrode assembly, composed of a cathode, an anode and a separator interposed therebetween, is impregnated within a lithium salt-containing, non-aqueous electrolyte.

When the binder of the present invention is used only in the anode out of two electrodes, the cathode may employ conventional binders known in the art. As examples of the conventional binders, mention may be made of polyvinylidene fluoride, polyvinyl alcohols, carboxymethylcellulose (CMC), starch, hydroxypropylcellulose, regenerated cellulose, polyvinyl pyrollidone, tetrafluoroethylene, polyethylene, polypropylene, ethylene-propylene-diene terpolymer (EPDM), sulfonated EPDM, styrene butadiene rubber, fluoro rubber, various copolymers, and polyvinyl alcohols having a high molecular weight and a high degree of saponification (DS).

The separator is interposed between the cathode and anode. As the separator, an insulating thin film having high ion permeability and mechanical strength is used. The separator typically has a pore diameter of 0.01 to 10 μm and a thickness of 5 to 300 μm. As the separator, sheets or non-woven fabrics made of an olefin polymer such as polypropylene and/or glass fibers or polyethylene, which have chemical resistance and hydrophobicity, are used. When a solid electrolyte such as a polymer is employed as the electrolyte, the solid electrolyte may also serve as both the separator and electrolyte.

The lithium salt-containing, non-aqueous electrolyte is composed of a non-aqueous electrolyte and lithium. As the non-aqueous electrolyte, a non-aqueous electrolytic solution, solid electrolyte and inorganic solid electrolyte may be utilized.

As the non-aqueous electrolytic solution that can be used in the present invention, for example, mention may be made of non-protic organic solvents such as N-methyl-2-pyrollidinone, propylene carbonate, ethylene carbonate, fluoro ethylene carbonate, butylene carbonate, dimethyl carbonate, diethyl carbonate, gamma-butyro lactone, 1,2-dimethoxy ethane, tetrahydroxy Franc, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate and ethyl propionate.

As examples of the organic solid electrolyte utilized in the present invention, mention may be made of polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

As examples of the inorganic solid electrolyte utilized in the present invention, mention may be made of nitrides, halides and sulphates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH and Li₃PO₄—Li₂S—SiS₂.

The lithium salt is a material that is readily soluble in the above-mentioned non-aqueous electrolyte and may include, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium, lithium tetraphenyl borate and imide.

Additionally, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the non-aqueous electrolyte. If necessary, in order to impart incombustibility, the non-aqueous electrolyte may further include halogen-containing solvents such as carbon tetrachloride and ethylene trifluoride. Further, in order to improve high-temperature storage characteristics, the non-aqueous electrolyte may additionally include carbon dioxide gas.

### EXAMPLES

Now, the present invention will be described in more detail with reference to the following examples. These examples are provided only for illustrating the present invention and should not be construed as limiting the scope and spirit of the present invention.

### Example 1

5% by weight of a polyvinyl alcohol having a degree of polymerization (DP) of 2600 and a degree of saponification (DS) of more than 99% was dissolved in dimethyl sulfoxide. To the resulting solution was added polyurethane, obtained by polymerization of polypropylene glycol (MW: ca. 450) and hexamethylene diisocyanate, in an amount of 10% by weight of the polyvinyl alcohol. The resulting solution was coated to a thickness of 500 μm on copper foil using a doctor blade, and was dried at 130° C. for 2 hours. Thereafter, the copper foil was removed to fabricate a polymer film.

### Example 2

A polymer film was fabricated in the same manner as in Example 1, except that polyurethane was added in an amount of 30% by weight of the polyvinyl alcohol.

### Comparative Example 1

5% by weight of a polyvinyl alcohol having a degree of polymerization (DP) of 2600 and a degree of saponification (DS) of more than 99% was dissolved in dimethyl sulfoxide. The resulting solution was coated to a thickness of 500 μm on copper foil using a doctor blade, and was dried at 130° C. for 2 hours. Thereafter, the copper foil was removed to fabricate a polymer film.

### Comparative Example 2

A polymer film was fabricated in the same manner as in Comparative Example 1, except that 11% by weight of polyvinylidene fluoride, which has been used as a binder of a conventional lithium secondary battery, was dissolved in N-methyl-2-pyrrolidone (NMP) as a dispersion medium.

### Comparative Example 3

A polymer film was fabricated in the same manner as in Comparative Example 1, except that 10 g of a urethane acrylate oligomer, known to have superior elasticity, and 0.3 g of benzoyl peroxide (BPO) as a thermal initiator were mixed in 100 g of NMP as a dispersion medium, thereby preparing a solution.

### Example 3

88 g of a silicon-graphite composite active material, 10 g of a polyvinyl alcohol having a degree of polymerization (DP) of 2600 and a degree of saponification (DS) of more than 99% and 1 g of polyurethane, obtained by polymerization of polypropylene glycol (MW: ca. 450) and hexamethylene diisocyanate, as set forth in Example 1, and 2 g of carbon black as a conductive material were mixed in dimethyl sulfoxide as a solvent, and the total content of solids was adjusted to 30% by weight, thereby preparing a slurry. The resulting slurry was coated to a thickness of 100 μm on copper foil using a doctor blade, and was dried in a drying oven at 130° C. for 30 min, followed by rolling it to an appropriate thickness to thereby fabricate an anode.

### Example 4

An anode was fabricated in the same manner as in Example 3, except that 3 g of polyurethane, a polymerization product of polypropylene glycol (MW: ca. 450) and hexamethylene diisocyanate, was added.

### Comparative Example 4

88 g of a silicon-graphite composite active material, 10 g of a polyvinyl alcohol having a degree of polymerization (DP) of 2600 and a degree of saponification (DS) of more than 99% as set forth in Comparative Example 1, as a binder, and 2 g of carbon black as a conductive material were mixed in dimethyl sulfoxide as a solvent, and the total content of solids was adjusted to 30% by weight, thereby preparing a slurry. The resulting slurry was coated to a thickness of 100 μm on copper foil using a doctor blade, and was dried in a drying oven at 130° C. for 30 min, followed by rolling it to an appropriate thickness to thereby fabricate an anode.

### Comparative Example 5

An anode was fabricated in the same manner as in Comparative Example 4, except that NMP is used instead of dimethyl sulfoxide, as a solvent, and 10 g of polyvinylidene fluoride is used instead of a polyvinyl alcohol.

### Comparative Example 6

An anode was fabricated in the same manner as in Comparative Example 4, except that NMP is used instead of dimethyl sulfoxide, as a solvent, 10 g of urethane acrylate is used instead of a polyvinyl alcohol, and 0.3 g of BPO is used as an initiator.

### Example 5

94 g of LiCoO₂ as an active material, 1.0 g of a conductive polymer and 5.0 g of a PVdF binder were mixed in NMP as a dispersion medium, and the total content of solids was adjusted to 45% by weight, thereby preparing a slurry. The resulting slurry was coated to a thickness of 100 μm on aluminum foil using a doctor blade, and was dried in a drying oven at 130° C. for 30 min, followed by rolling it to an appropriate thickness to thereby fabricate a cathode.

A separator made of a microporous polyolefin film was interposed between the anode of Example 3 and the cathode fabricated as above, thereby fabricating a coin cell. Thereafter, an electrolyte of 1M LiPF₆ in a mixed solvent of EC (ethyl carbonate):DEC (diethyl carbonate):EMC (ethyl-methyl carbonate) (4:3:3, v/v) was introduced into the resulting electrode assembly to prepare a lithium secondary battery.

### Example 6

A lithium secondary battery was fabricated in the same manner as in Example 5, except that the anode fabricated in Example 4 was used.

### Comparative Example 7

A lithium secondary battery was fabricated in the same manner as in Example 5, except that the anode fabricated in Comparative Example 4 was used.

### Comparative Example 8

A lithium secondary battery was fabricated in the same manner as in Comparative Example 7, except that the anode fabricated in Comparative Example 5 was used.

### Comparative Example 9

A lithium secondary battery was fabricated in the same manner as in Comparative Example 7, except that the anode fabricated in Comparative Example 6 was used.

### EXPERIMENTAL EXAMPLES

The following experiments were carried out to analyze characteristics of polymer films and electrodes fabricated according to the present invention.

### Experimental Example 1

In order to measure the swelling degree of the polymer films in a lithium salt-free electrolyte, EC (ethyl carbonate): DEC (diethyl carbonate): EMC (ethyl-methyl carbonate) were mixed in a ratio of 4:3:3 (v/v). The polymer films fabricated in Examples 1 and 2 and Comparative Examples 1 to 3 were cut into round samples having a diameter of 1 cm, and soaked in 10 mL of the resulting mixed solution which was then sealed and stored in an incubator at 25° C. 120 hours later, the films were taken from the electrolyte and the remaining electrolyte on the film surface was wiped with a dry paper, followed by measuring changes in the weight of films relative to the initial weight. The swelling rate of the polymer films in the electrolyte was calculated according to the following equation. For evaluation, the swelling rate (%) was measured for more than 5 samples and the average value was calculated. The experimental results thus obtained are given in Table 1 below.
Swelling rate (%)=(weight after soaking in electrolyte−weight before soaking in electrolyte)/(weight before soaking in electrolyte)×100

### Experimental Example 2

An experiment was carried out in the same manner as in Experimental Example 1, except that a mixed solution of EC (ethyl carbonate):DEC (diethyl carbonate):EMC (ethyl-methyl carbonate) (4:3:3, v/v) containing 1M LiPF₆ was used to measure the swelling degree of the polymer films in a lithium salt-containing electrolyte. The experimental results thus obtained are given in Table 1 below.

### Experimental Example 3

In order to measure the elasticity of the polymer films of the present invention, experiments were carried out according to ASTM D638 standard test method. The experimental results thus obtained are given in Table 1 below. For evaluation, the elasticity was measured for more than 5 samples and the average value was calculated.

TABLE 1

| | Swelling in | | |
|---|---|---|---|
| | lithium salt-free | Swelling in lithium salt- | Elasticity |
| | electrolyte (%) | containing electrolyte (%) | (%) |
| Ex. 1 | 4.58 | 7.48 | 42.30 |
| Ex. 2 | 8.75 | 12.69 | 106.81 |
| Comp. Ex. 1 | −12.83 | 2.69 | <10 |
| Comp. Ex. 2 | 7.28 | 9.54 | <10 |
| Comp. Ex. 3 | 44.4 | 52.77 | 140.26 |

As can be seen from the experimental results, the polyvinyl alcohol binder of Comparative Example 1 was dissolved in a carbonate-based electrolyte, whereas the polyvinyl alcohol/polyurethane crosslinked polymer binders of Examples 1 and 2 were not dissolved in the electrolyte and exhibited electrolyte-containing characteristics similar to PVdF of Comparative Example 2 having superior electrolyte resistance. In addition, it was confirmed that the binders of Examples 1 and 2 remarkably improve the elasticity of the polyvinyl alcohol via crosslinking with polyurethane.

### Experimental Example 4

In order to measure the adhesive strength between an electrode active material and current collector when the polymer films of the present invention were used as a binder, the surface of the fabricated electrode was cut into a predetermined size and mounted on a slide glass. Then, the current collector was peeled off while 180-degree peel strength was measured. In addition, the electrode was soaked in the above lithium salt-free electrolyte (see Experimental Example 1) for 120 hours, and thereafter the electrolyte was thoroughly dried and the peel strength was measured in the same manner as above. The results thus obtained are given in Table 2 below. For evaluation, the peel strength was measured for more than 5 samples and the average value was calculated.

TABLE 2

| Electrode adhesive | | | Comp. | | |
|---|---|---|---|---|---|
| strength (g_{f}/cm) | Ex. 3 | Ex. 4 | Ex. 4 | Comp. Ex. 5 | Comp. Ex. 6 |
| Fresh electrode | 487 | 393 | 678 | 21 | 75 |
| Electrolyte-soaked | 463 | 356 | 251 | <5 | 27 |
| electrode | | | | | |

As can be seen from Table 2, when the adhesive strength of the fresh electrode was measured prior to charge/discharge cycles, the adhesive strength of the polyvinyl alcohol was slightly lowered due to crosslinking with polyurethane (Examples 3 and 4). However, due to solubility in a carbonate-based electrolyte, the polyurethane-uncrosslinked polyvinyl alcohol binder (Comparative Example 4) exhibited a decrease of electrode adhesive strength as a contact time with the electrolyte increases. On the other hand, it can be seen that the polyurethane-crosslinked polyvinyl alcohol (Examples 3 and 4) has retained the inherent adhesive strength thereof.

Further, it can be seen that the polyvinyl alcohol/polyurethane crosslinked binder exhibits superior adhesive strength, as compared to the PVdF binder used in conventional carbon-based electrodes and the urethane acrylate binder having superior elasticity.

### Experimental Example 5

In order to evaluate the performance of coin cell batteries, 2 cycles of charge/discharge at 0.1 C rate and 50 cycles of charge/discharge at 0.5 C rate were respectively repeated for the batteries, according to a constant-current/constant-voltage method. The initial capacity and efficiency, the efficiency after charge/discharge cycles, and the volume expansion were compared between the respective batteries. For this purpose, more than 5 coin cell batteries were respectively fabricated for the same binder composition, and evaluation was carried out and the average value was calculated. The results thus obtained are given in Table 3 below.

TABLE 3

| | | Initial | Electrode volume | 50-cycle |
|---|---|---|---|---|
| | Initial capacity | efficiency | expansion after | efficiency |
| | (mAh/g) | (%) | 50 cycles (%) | (%) |
| Ex. 5 | 2028.39 | 78.6 | 392 | 73.6 |
| Ex. 6 | 2010.72 | 77.3 | 357 | 72.3 |
| Comp. Ex. 7 | 2034.46 | 77.8 | 496 | 63.8 |
| Comp. Ex. 8 | 1822.54 | 73.5 | — | 63.2 |
| Comp. Ex. 9 | 2352.76 | 74.3 | — | <20 |

As can be seen from Table 3, the use of a polyvinyl alcohol/polyurethane-crosslinked binder (Examples 5 and 6) exhibited similarities in the initial capacity and initial efficiency, but showed better performance in cycle characteristics, the most important factor of the battery, as compared to a single use of a polyvinyl alcohol as a binder (Comparative Example 7). As can be seen from the volume expansion rate given in Table 3, this is because, as discussed hereinbefore, crosslinking of the polyvinyl alcohol with polyurethane having superior elasticity leads to improved elasticity and electrolyte resistance of the polyvinyl alcohol, thereby retaining the adhesive strength of the electrode and minimizing occurrence of electrode cracking during charge/discharge cycles.

Further, the battery of the present invention exhibited superior initial capacity, initial efficiency and cycle efficiency, as compared to the battery using the conventional PVdF binder (Comparative Example 8). In addition, the battery of the present invention exhibited much better efficiency, as compared to the battery using the urethane acrylate binder having superior elasticity and resistance while showing excessive swelling in the electrolyte and thereby low adhesive strength (Comparative Example 9).

### INDUSTRIAL APPLICABILITY

As apparent from the above description, a polyurethane-crosslinked polyvinyl alcohol binder according to the present invention and a lithium secondary battery comprising the same enable stable maintenance of adhesion between active materials and/or adhesion between the active material and current collector, despite significant volume changes of anode active materials particularly during repeated charge/discharge cycles, via the use of a polymer having improved electrolyte resistance and elasticity while exhibiting very high adhesive strength as a binder of an electrode mix. Further, the present invention enables commercialization of a high-capacity silicon- or tin-based anode active material, and it is therefore possible to manufacture a large-capacity lithium secondary battery.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A binder for an electrode mix of a secondary battery, comprising a crosslinked copolymer of a polyvinyl alcohol crosslinked with polyurethane.

2. The binder according to claim 1, wherein the polyvinyl alcohol has a degree of polymerization of more than 2000 and a degree of saponification of more than 80%.

3. The binder according to claim 1, wherein the polyurethane has a molecular weight of 1000 to 150,000.

4. The binder according to claim 1, wherein the polyurethane is contained in an amount of 0.1 to 100 parts by weight, based on 100 parts by weight of polyvinyl alcohol.

5. An electrode for a secondary battery fabricated by using an electrode mix containing the binder of claim 1.

6. The electrode according to claim 5, wherein the electrode is an anode.

7. The electrode according to claim 6, wherein the anode contains a carbon-, silicon-, tin-, or silicon/carbon-based active material.

8. The electrode according to claim 5, wherein the binder is contained in an amount of about 1 to 50% by weight, based on the total weight of the electrode mix.

9. The electrode according to claim 5, wherein the crosslinking reaction between the polyvinyl alcohol and polyurethane takes place during the fabrication process of the electrode involving applying to a current collector an electrode slurry, prepared by adding to a solvent an electrode mix containing an electrode active material, a polyvinyl alcohol, and a polyurethane having isocyanate groups at both ends thereof, followed by drying and rolling.

10. The electrode according to claim 5, wherein the electrode mix further includes at least one material selected from the group consisting of a cross-linking accelerator, a viscosity adjuster, a conductive material, a filler, a coupling agent, an adhesive accelerator, and any combination thereof.

11. A lithium secondary battery comprising the electrode of claim 5.
